(19) United States
(12) Patent Application Publication
(10) Pub. No.: US 2002/0109347 A1
(43) Pub. Date: Aug. 15, 2002

(54) Apparatus for reducing road vehicle spray

(76) Inventor: Lynn John Sheppard, Bagshot (GB)

Correspondence Address: ROBERT W. J. USHER, PATENT AGENT, 1133 BROADWAY, #1515, NEW YORK, NY, 10010

(21) Appl. No.: 09/780,934

(22) Filed: Feb. 9, 2001

(51) Int. Cl. B62B 9/14

(52) U.S. Cl. 280/851; 280/847

(57) ABSTRACT

Apparatus for reducing road vehicle spray comprises a partial enclosure (10) for a vehicle road wheel (1), defined by a top wall (2), a rear wall (20), and a side wall (12). The rear wall is provided with means for collecting water from water spray in the partial enclosure, the front (28) of the partial enclosure is substantially open and a side wall is provided with one or more air scoops (15) for directing air passing outside the enclosure into the enclosure. The air scoops create an air flow through the enclosure, which can lower the pressure at the front air intake, to suck in, and reduce the effects of, front wheel spray (6), and also cool the tires, while the apparatus also suppresses rear wheel spray (6).

This invention relates to apparatus for reducing road vehicle spray. It is a common experience that road surface water is thrown up by the wheels, especially the rear wheels, of heavy road vehicles, to form potentially lethal plumes of spray, which severely reduce visibility for following or overtaking vehicles.

It is an object of the invention to provide apparatus that can be fitted to road vehicles, and in particular to heavy goods vehicles such as articulated lorry trailers, container lorries or tankers, as original equipment or as retrofit equipment for the aftermarket, for reducing such spray.

Many previous attempts have been made to control road vehicle spray, and many proposals exist for tackling the problem. For example, it is possible to exhaust spray mist as such from the wheel arch through openings in the inner face of the wheel arch, such that large volumes of mist are taken to a point at which water can be separated and discharged. It is also possible to catch water spray on a mud flap at the rear of the wheel arch, and provide gutters by which the caught water can be discharged back to the road behind the wheels.

According to the present invention, it is proposed to catch water spray on a specially adapted rear wall behind a road wheel, inside an enclosure for the wheel, and take the caught water away from the region of the wheel, with its turbulent air flows, while simultaneously extracting airborne spray droplets.

It has been observed that the spray pattern that is thrown out by a heavy vehicle such as an articulated lorry tends to exhibit a relatively minor spray thrown out by the front wheels, but often a vortex or natural suction pattern draws this spray back into the rear wheels, from which much denser spray is generated. Accordingly, in the invention, it is also proposed to draw airborne spray thrown up by forward sets of wheels into spray reducing apparatus physically associated with a rearward set of wheels.

The present invention concerns aspects of the apparatus described below. The scope of the invention extends to all novel aspects of the apparatus, whether individually or in combination with any of the other features disclosed herein.

In one aspect of the invention apparatus for reducing road vehicle spray may comprise a partial enclosure for a vehicle road wheel, the partial enclosure being defined by a top wall above the road wheel, a rear wall behind the road wheel (determined in accordance with the normal direction of forward motion of the vehicle), and a side wall depending from the top wall and extending forwardly from the rear wall on each side of the road wheel. Suitably, the rear wall is provided with means for collecting water from water spray in the partial enclosure, the front of the partial enclosure is substantially open and a side wall is provided with one or more air scoops for directing air passing outside the enclosure into the enclosure.

The front of the enclosure is left substantially open in order to form a large air intake into the enclosure. In traffic, on wet roads, there will be spray thrown up by other vehicles in the air drawn in to the enclosure; and when the apparatus is fitted behind other road wheels on the same vehicle, and especially when fitted to trailer wheels, the front air intake is especially valuable in drawing in the spray thrown up by other wheels. Any front wall of the enclosure dependent from the top wall may be substantially shorter than the side and rear walls, so as to leave an open air intake into the enclosure ahead of the road wheel.

The air scoops provided in the side walls create an air flow through the enclosure, when the vehicle is moving at sufficient speed, which can lower the pressure at the front air intake. This is believed to be particularly effective when the air scoops are alongside the wheel, and inject a further airflow into the air already moving through the narrow passage between the side walls and the wheel. Because of the air flow patterns around moving heavy road vehicles—which, although they do of course vary with individual designs, often show an inflow of front wheel spray towards trailing wheel sets—apparatus fitted to a rear wheel set, with suitably positioned air scoops, can in many cases be effective to suck in, and reduce the effects of, front wheel spray, as well as suppressing rear wheel spray to a significant extent.

One or more air scoops may be situated whereby to direct brake cooling air into the partial enclosure in the region of a wheel hub. One or more air scoops may be situated whereby to direct tire cooling air into the partial enclosure in the region of a wheel tire.

The enclosure may be provided with an air extractor duct. Spray laden air may be extracted from this partial enclosure through this duct, which may open from the enclosure on or adjacent the rear wall. The use of an extractor such as a pump to extract air from the enclosure, behind the wheel, assists the air intake function, as well as assisting the water extraction function of the apparatus.

The top wall may be provided by a conventional wheel arch, mudguard or fender, or may be any other part of the vehicle body above the wheel, or may be a part designed for the purpose of the invention. The lower edges of the side walls and of the rear wall may reach close to the road surface, to enhance the extraction of spray laden air into and from the enclosure. The side walls and rear walls may be provided by extension panels affixed sealingly to side edges and a rear edge of whatever serves as the top wall. Such panels can be provided as a kit of parts in accordance with the invention, for the conversion of an existing wheel arch or mudguard into apparatus according to the invention. Whether provided as part of a conversion or as original equipment, the outer side wall may be retained by quick release fastenings, to allow tires to be inspected and wheels to be changed without inconvenience.

Some further preferred embodiments of the invention are set out below.

The rear wall may comprise a panel with a forward face towards the interior of the enclosure, an internal chamber in the panel behind the forward face, apertures in the forward face for admitting water into the chamber, and a water outlet from the chamber. Drain channels may be provided on the rear wall, for collecting water thrown against the wall, and a water extractor duct may be connected to the drain channels.

For typical trucks currently carrying freight on British motorways, the side walls may reach to within 150 mm of the road surface when the vehicle is unladen, and may reach to within 50 mm of the road surface when any suspension for the road vehicle wheel is compressed to its maximum extent. In general, relating the invention to wheel size for a wheel with a pneumatic tire, the side walls of the partial enclosure may have lower edges situated alongside the inflated pneumatic tire vertically below the wheel hub. Having regard to the low side walls and rear wall of the partial enclosure, they may be hinged whereby they can be raised for travel of the vehicle over uneven ground, or even over curbs.

Two embodiments of the invention are shown, by way of example, in the accompanying diagrammatic drawings, in which:

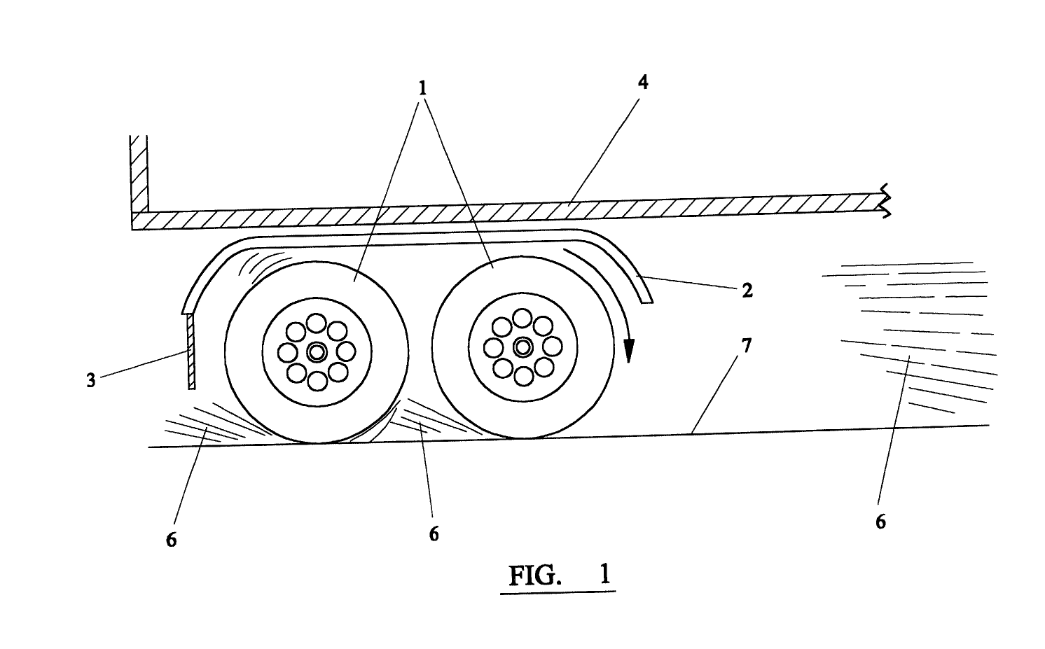

FIG. 1 is a side elevation illustrating a conventional double axle rear wheel set of a heavy goods trailer;

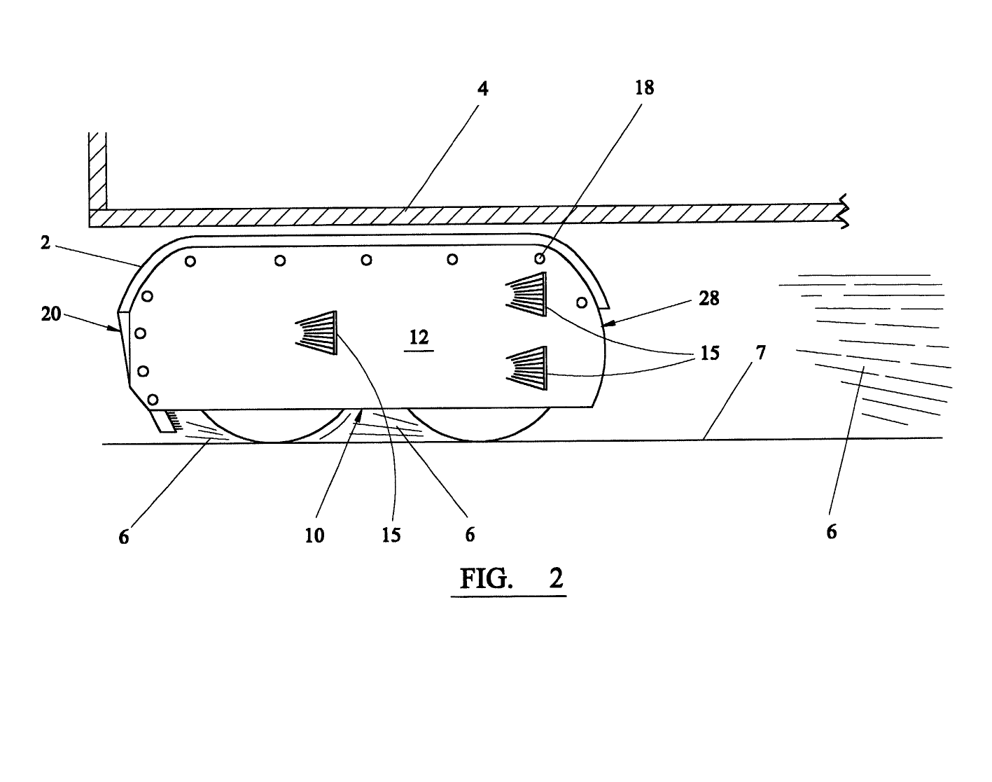

FIG. 2 is a corresponding view showing the same trailer wheels fitted with a first embodiment of apparatus in accordance with the invention;

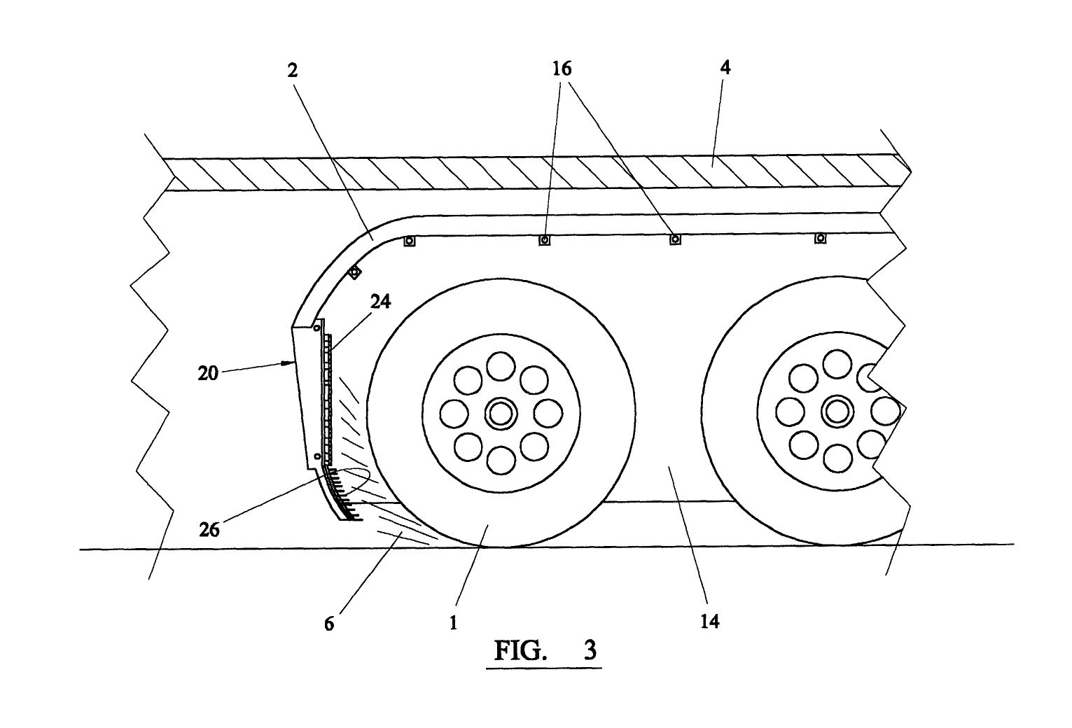

FIG. 3 corresponds to FIG. 2, with the outer side panel of the apparatus removed;

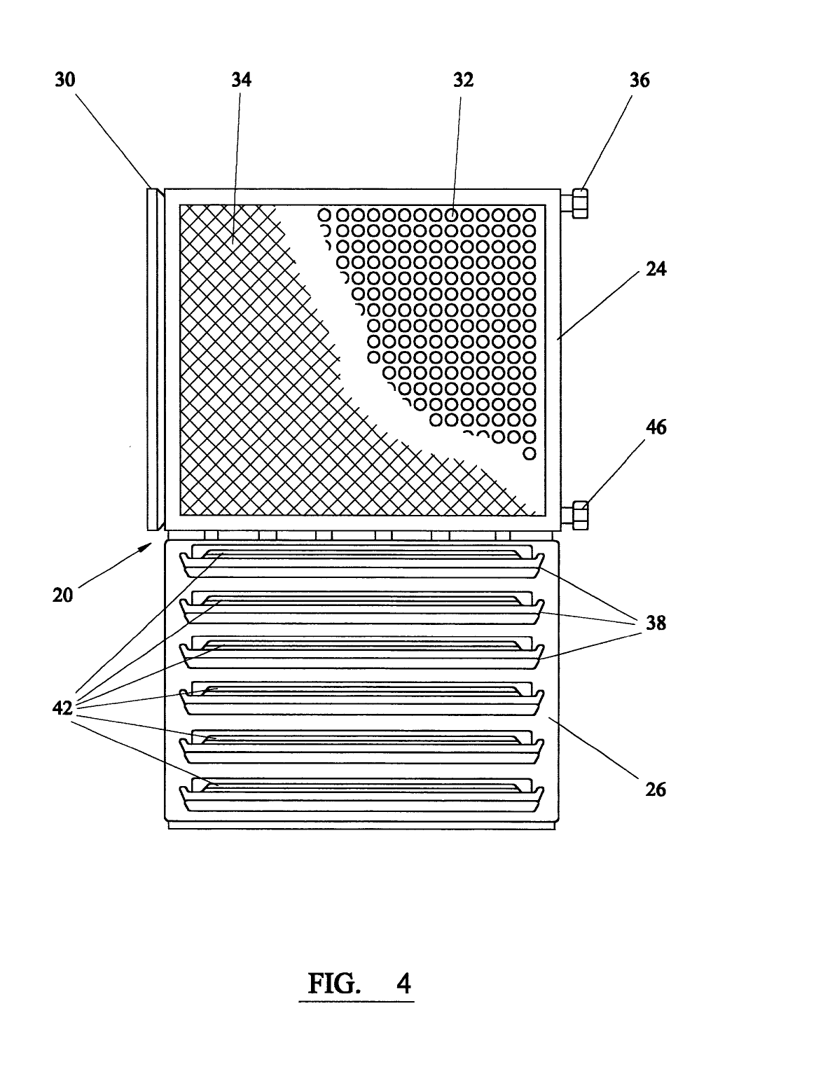

FIG. 4 is a front view of the rear wall of the apparatus;

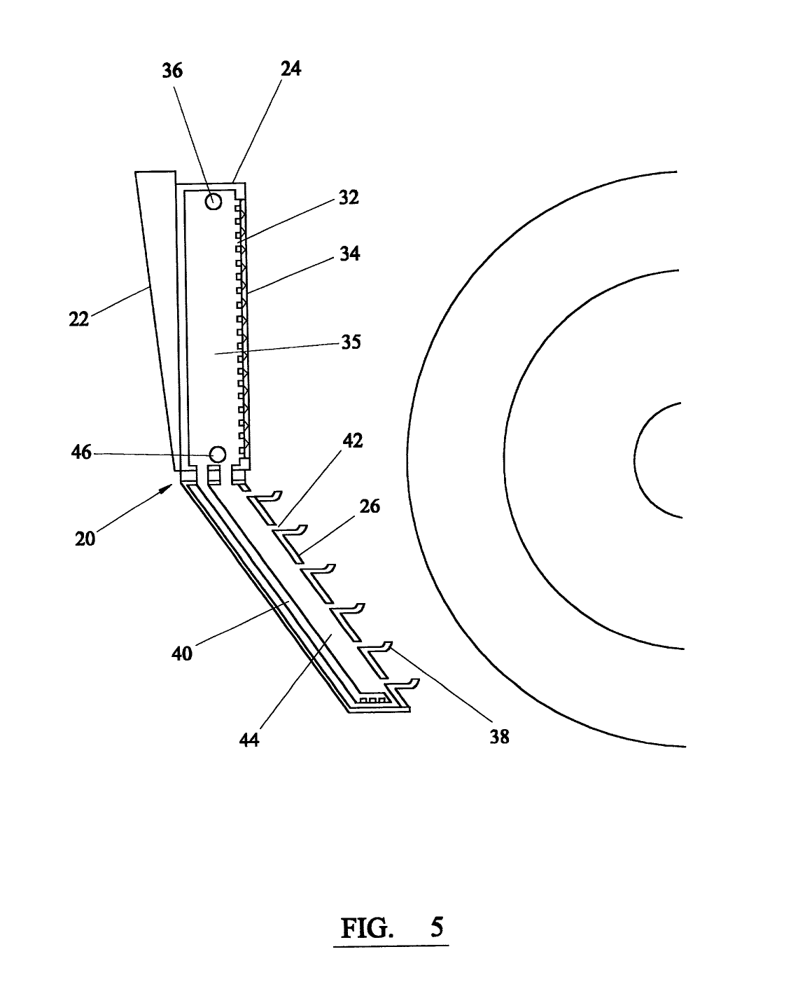

FIG. 5 is a side view, in section, of the rear wall of the apparatus;

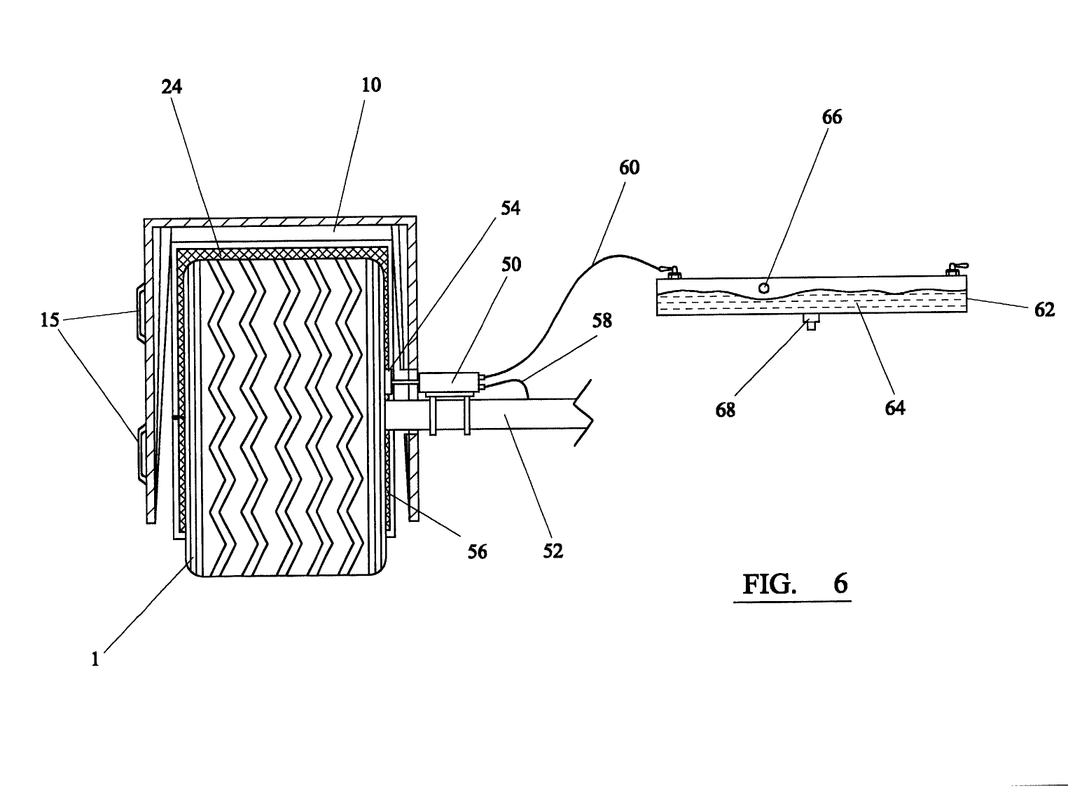

FIG. 6 is a cross-sectional view through the apparatus, looking in a rearward direction;

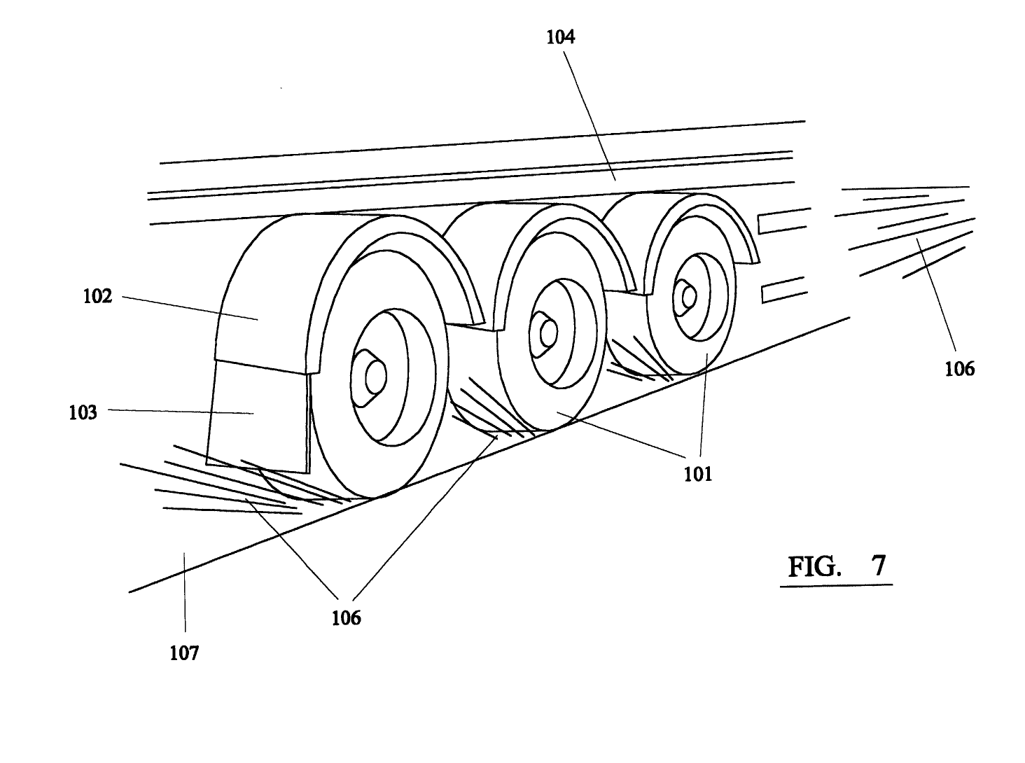

FIG. 7 is a perspective view illustrating a conventional tri-axle rear wheel set of a heavy goods trailer;

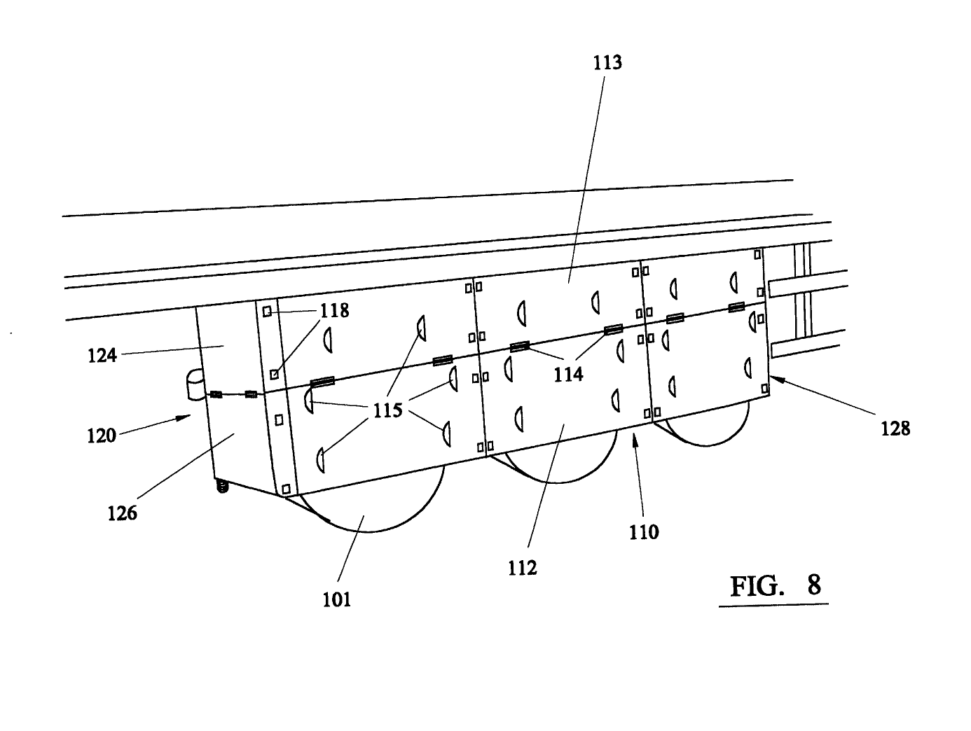

FIG. 8 is a similar view showing the same trailer wheels fitted with a second embodiment of apparatus in accordance with the invention;

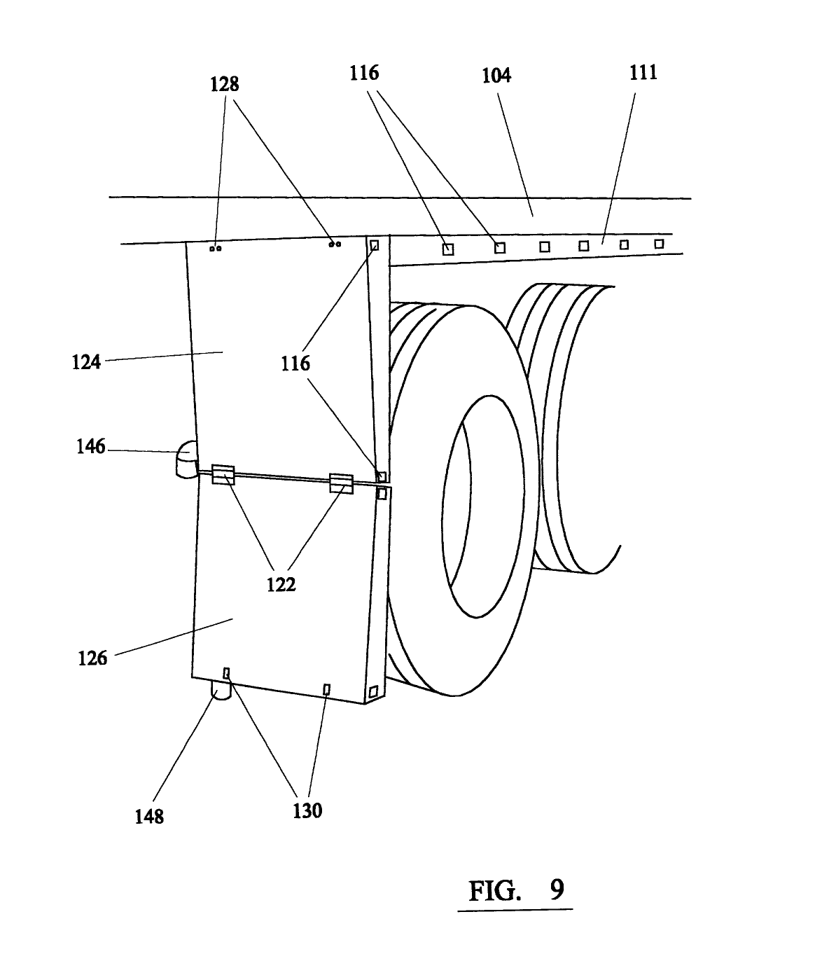

FIG. 9 is a view from a similar viewpoint as in FIG. 8, showing the rear wall panel in more detail, the side panels being removed;

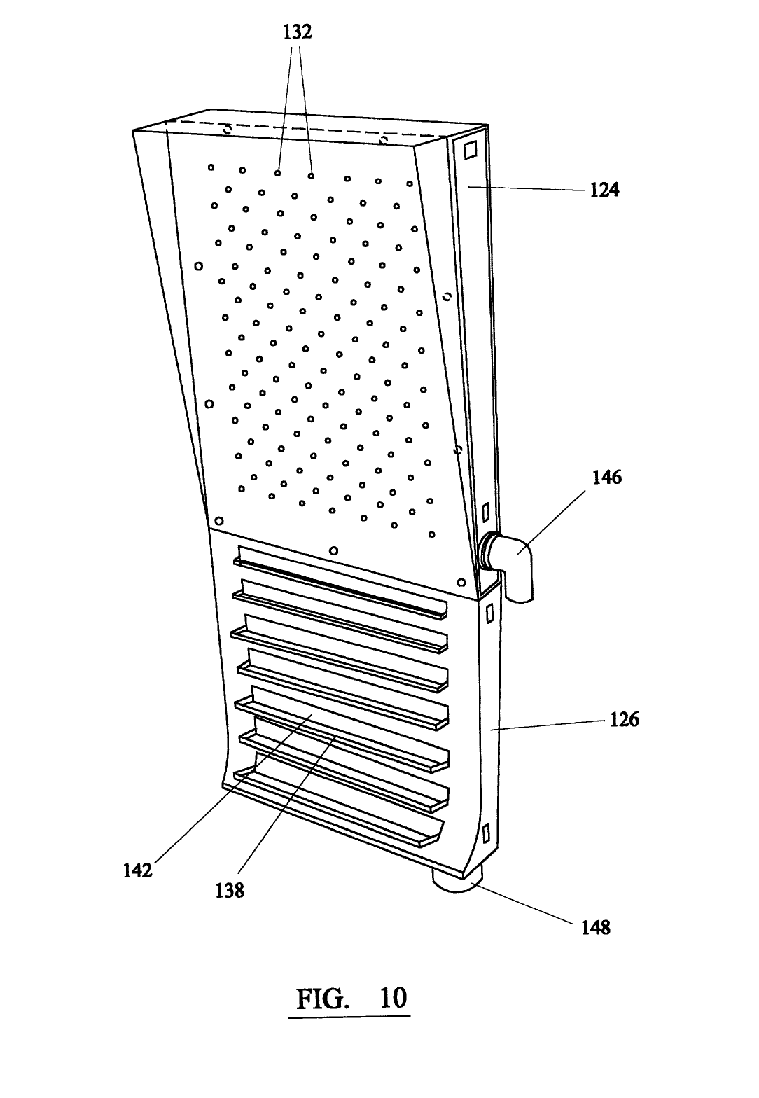

FIG. 10 is a perspective view of the rear wall panel from the front and one side;

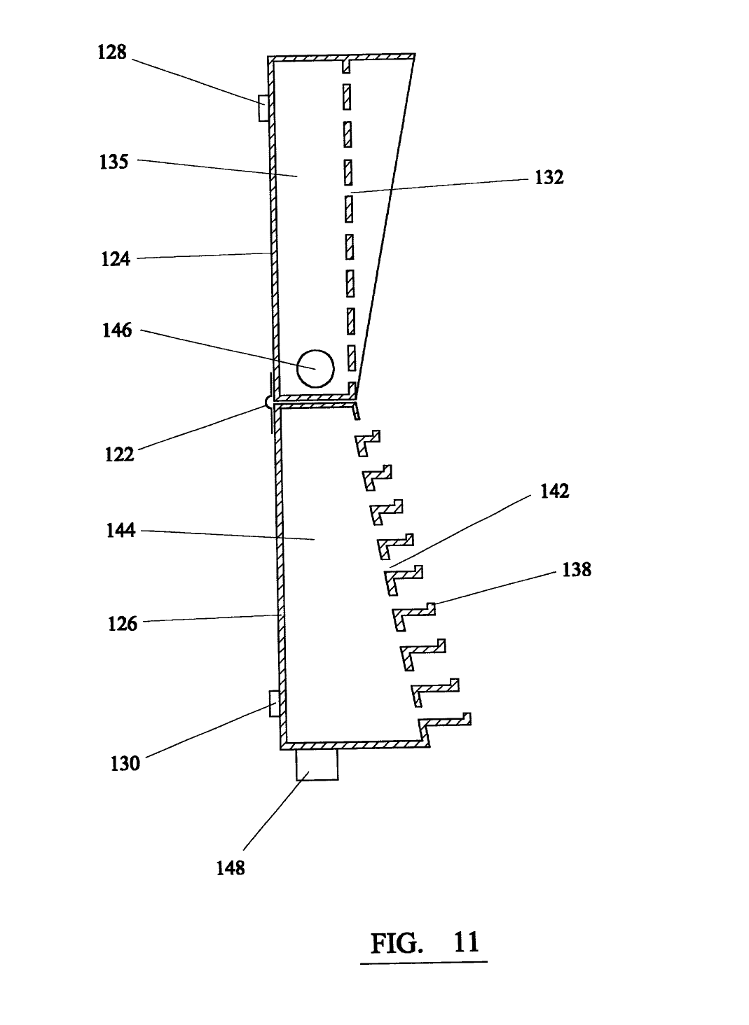

FIG. 11 is a cross section through the rear wall panel of the second embodiment of the invention, corresponding to the FIG. 5 view of the first embodiment; and

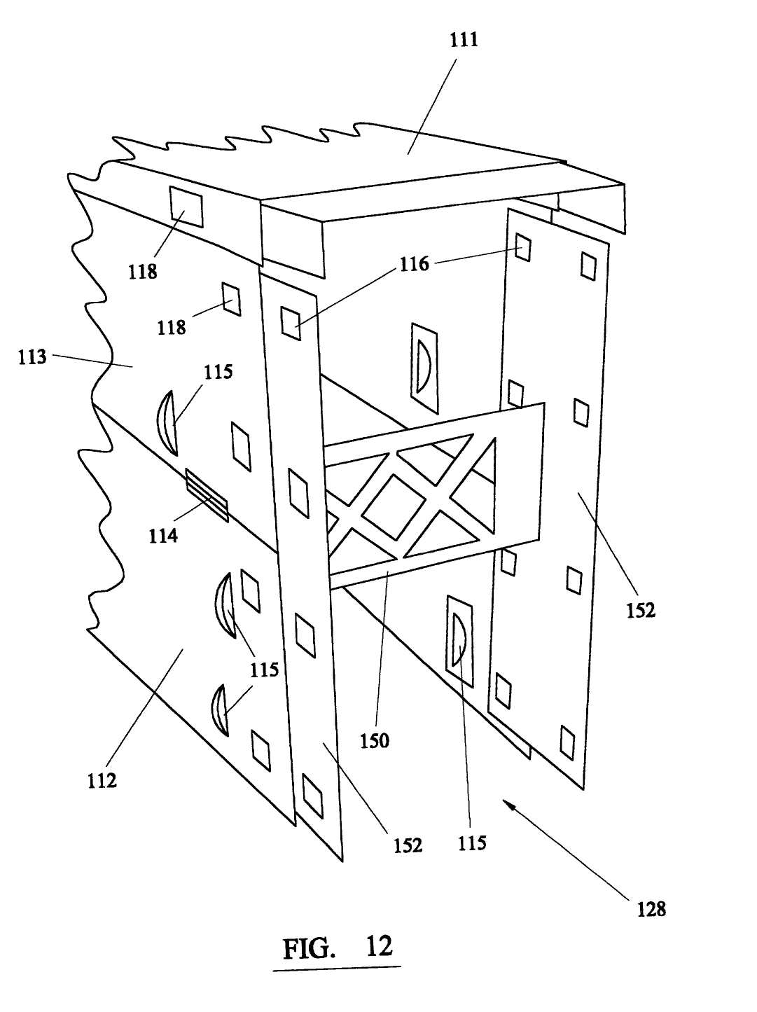

FIG. 12 is a perspective view of part of the enclosure, from the front and one side.

As shown in FIG. 1, rear wheels 1 of a conventional trailer are located under a standard wheel arch 2, provided with a flexible hanging rear mud flap 3 of rubber or the like, under a trailer bed 4. Water spray 6, consisting of a range of droplet sizes down to a fine mist, is thrown up by each wheel from a wet road surface 7.

When modified in accordance with the invention, either during manufacture or by the addition of a kit of parts, the visible external appearance of the wheel set is as shown in FIG. 2. The mud flap 3 has been removed, and an enclosure 10 for reducing spray has been fitted. This consists of a pair of side wall panels, one on each side of the wheels, of which the outer panel 12 can be seen in FIG. 2, and the inner panel 14 in FIG. 3. The outer panel is provided with three staggered air scoops 15 to direct passing air into the enclosure

As shown in FIGS. 2 and 3 together, side wall panel fixing points 16 are provided inside the wheel arch 2, and corresponding holes 18 are provided around the edge of the side wall panels through which a convenient form of “one turn” speed fastener can pass to hold the wall panels in place, and allow quick panel removal for wheel access. A sealing strip (not shown) between wall panels and wheel arch prevents leakage.

A rear wall 20 is affixed to the rear edge of the wheel arch and the rear edges of the side wall panel. The rear wall consists of an upper suction panel 24 and a lower drain panel 26. The suction panel is principally intended for removal of spray laden air, and the drain panel for the removal of liquid water, as will be described, although in practice each will extract both air and water from the inside of the partial enclosure 10 formed by the two wall panels, the wheel arch and the rear wall. This enclosure is open at the front 28, forming an air scoop which, with the side air scoops 15, collects spray thrown up by the front wheels of the vehicle and drawn towards the rear wheels by air flow past the vehicle. Even in dry conditions, these scoops direct brake-cooling air into the enclosure 10 in the region of the wheel hubs.

The lower edges of the side walls 12, 14 are typically about 75-100 mm from the road surface 7, and the lower edge of the rear wall 20, at the bottom of drain panel 26, is even lower, about 50-75 mm from the road surface. Drain panel 26 is mounted with its lower edge angled forwards, so that it lies approximately parallel with the tire of rear wheel 1.

The suction panel 24 (FIGS. 4 and 5) extends the full width of the enclosure 10 (FIG. 6), which may be wide enough for one, as shown in the drawings, or more typically two road wheels side by side, in which case two adjacent panels can be joined by connector 30. The suction panel has, on its face towards the interior of the enclosure 10, a plurality of apertures 32, covered by a fine grill or mesh cover 34. This cover is to prevent stones or foreign bodies from entering and blocking the apertures. The apertures all connect within the panel to chamber 35 which is evacuated through outlets 36, 46 respectively at the top and bottom of one side of the suction panel.

The lower drain panel 26 is provided with a plurality of horizontally extending lips 38. The lower panel is angled so that the lower portion of the panel inclines forwardly. Above each lip 38 is a horizontal aperture extending across the greater part of the width of the panel, forming a drain channel or slot 42, into which liquid water running down the panel is directed by the corresponding lip. Each aperture opens into chamber 44, from which air is extracted to suction panel chamber 35, and from which liquid water is extracted by means of pipe 40 from the bottom of drain panel chamber 44 to outlet 46 at the base of the upper suction panel.

In use, outlet 36 is a duct connected to an extractor pump and outlet 46 is a duct connected to a water removal pump. In practice, the same pump may be connected to both outlets. As the vehicle travels forwards over a wet road, the high capacity pump extracts air from the enclosure 10, which is largely replaced by front wheel spray drawn in through the air scoops 15 and the scoop formed by the open front end 28. By using the scoops in the side panel, air is drawn into the enclosure into the space between the side panel and the wheel by the forward motion of the vehicle. This additional air flow from side to back inside the enclosure is believed to assist in drawing air into the open front of the enclosure, by inducing a reduced pressure inside the front of the partial enclosure. The extractor pump likewise assists in reducing air pressure, so that, at the front of the enclosure, airborne spray thrown up from ahead of the apparatus is drawn into the enclosure and the water in the spray is then condensed and removed at the rear wall panel.

Heavier water droplets thrown up by the wheels 1 tend to collect on the drain panel 26, either directly or by running down from the mesh 34, while finer spray droplets are entrained in air passing through the mesh and into the suction holes 32 of the suction panel 24.

FIG. 6 shows one possible arrangement for providing pump suction and collecting the extracted water. A simple vacuum pump 50 is mounted on the rear axle 52, taking a quiet and cushioned friction drive by means of a rubber sleeved drive wheel 54 from the inside of wheel rim 56. A simple clutch (not shown) is provided to connect the drive wheel 54 to the internal pump mechanism as required An inlet hose 58 draws in air and water from chamber outlets 36 and 46, and an outlet hose 60 delivers the air and water to a reservoir tank 62, where the extracted water 64 is stored. The reservoir is centrally located under the trailer bed, and is also fed by exactly similar spray reducing apparatus on the opposite side of the vehicle, in which all the elements described are duplicated.

The accumulated water may be disposed of in various ways. In some vehicles, it may be used for the brake cooling system. An overflow pipe 66 may be provided to vent air and to allow excess liquid water to run out on to the road under the vehicle, away from the wheels, and a drain valve 68 may also be included.

The second embodiment of the invention is applied to the rear wheel set shown in FIG. 7. Three in-line rear wheels 101 of an articulated trailer are provided with mudguards 102 and rear mud flap 103 under a trailer bed 104. Water spray 106 is thrown up from wet road surface 107.

In order to apply apparatus according to the invention to the wheel set as shown in FIG. 8, mudguards 102 and mud flap 103 are entirely removed, so that a partial enclosure 110 can be assembled around wheels 101. In this case, a distinct top wall 111 (FIGS. 9,12) is fastened directly to the underside of trailer bed 104, and fittings on the vehicle previously used to attach mudguards 102 are adapted as required to support the remainder of the apparatus, which is also fastened to the top wall.

The essentials of the partial enclosure are provided by side wall panels and rear wall panels. An upper rear panel 124 and a lower rear wall panel 126, joined by hinges 122, together make up the rear wall 120. Each of the three wheels 101 has, on each side of it, an upper side wall panel 113 fastened sealingly to top wall 103, and a lower side wall panel 112 which is jointed by hinges 114 to the lower edge of the upper panel 113. The hinges 114, 122 allow the lowest wall panels of the enclosure to be raised so that the vehicle can travel over uneven surfaces without damaging the apparatus.

The side wall panels, rear wall panels and the top wall are all interconnected by speed fasteners 118, with appropriate use of sealing strips between the wall components.

Each of the side wall panels 112, 113 is provided with air inlet scoops 115, which are generally arranged so that they direct air flowing past the outside of the enclosure in to the region of the tires. In addition to benefiting the airflow through the enclosure, this gives enhanced tire cooling, as will be described below.

The front of partial enclosure 110 is entirely open, forming an air intake 128.

FIG. 9 shows more detail, illustrating the fixing points 116 for the speed fasteners in the rear wall panels and in the top wall 111. Mutually complementary snap fasteners, or optionally magnetic fasteners, indicated at 128 on upper rear wall panel 124 and at 130 on lower rear wall panel 126, provide the means of retaining the lower panel when it is hinged up quickly to increase ground clearance. Similar means are provided for the side wall panels 112, 113.

FIGS. 10 and 11 show rear wall 120 comprising two hollow panels. The upper panel 124 has a front face perforated with apertures 132 that are large enough not to become clogged with mud from the water spray to which they are exposed; rather, the water washes any deposits through the apertures, into the internal chamber 135. A grill over the upper panel is optional. Water, air and solids are all discharged through outlet duct 146 which leads the water and solids, by gravity flow, to a reservoir (not shown, but similar to tank 62, FIG. 6) under the trailer bed 104.

The lower panel 126 is similar in essentials to panel 26, FIGS. 4 and 5, with lips 138 and apertures 142 leading liquid water to the interior chamber 144. However, the liquid water drains from chamber 144 by outlet duct 148 directly on to the road surface. It is found that a narrow stream of water does not create significant new spray, but if water were to fall from the panel in a sheet, it would at once revert to spray. The face of panel 126 curves forward nearer the road surface, as lips 138 also reach further forward, to better collect water behind the nearest wheel and direct it into the chamber 144.

FIG. 12 shows a detail of the air intake 128. The structure shown is replicated over each road wheel 101. An H shaped brace is made up of side pieces 152 and a central cross member 150. The side pieces provide fixing points 116 for fasteners 118 on adjacent side panels 112 and 113.

The cross member 150 lies ahead of a wheel, is perforated for good air flow, and maintains the separation of the side walls.

In both illustrated embodiments of the invention, there is a low pressure region maintained at the inlets 28, 128 to the partial wheel enclosures by the action of the side scoops 15, 115 and any extractor pump or pumps, which draws road water spray into the apparatus for water removal.

Tests were carried out using apparatus as described with reference to FIGS. 7 to 12, on a Frauhof tri-axle curtain side trailer, maximum load 22.5 tonnes, drawn by an articulated tractor unit, with three wheels in line on each side as illustrated. The tire sizes were 385/65 R22.5, and the trailer was about half laden, carrying about 10 tonnes.

The lower edges of the side and rear walls were 120 mm from the road surface; the pneumatic suspension would allow 100 mm compression, leaving a safety clearance of at least 20 mm from the road surface.

By fitting the apparatus to one side only, visual comparisons could be made of effectiveness at a road speed of about 100 kph (60 mph). Effective spray reduction by the apparatus was observed.

At the same time, tire wall temperatures were measured. The starting temperature was 14.1° C.

After 160 km (100 miles) the tire wall temperatures were 20.6° C. inside the apparatus, and 22.4° C. on the open side. After 457 km (284 miles) the respective temperatures were 21.3° C. and 22.3° C. This demonstrates that as well as reducing spray, the apparatus aids cool tire running, presumably by the enhanced air flow past the tires, despite the enclosure of the wheels.

I claim:

1 Apparatus for reducing road vehicle spray comprising a partial enclosure for a vehicle road wheel, the partial enclosure being defined by a top wall above the road wheel, a rear wall behind the road wheel (determined in accordance with the normal direction of forward motion of the vehicle), and a side wall depending from the top wall and extending forwardly from the rear wall on each side of the road wheel, the partial enclosure having a front which is substantially open, and a side wall being provided with one or more air scoops for directing air passing outside the enclosure into the enclosure; wherein the rear wall comprises a panel with a forward face towards the interior of the enclosure, an internal chamber in the panel behind the forward face, apertures in the forward face for admitting into the chamber water collected from water spray in the partial enclosure, and a water outlet from the chamber.

2 Apparatus according to claim 1, wherein the side walls reach to within 150 mm of the road surface when the vehicle is unladen.

3 Apparatus according to claim 1 wherein the side walls reach to within 50 mm of the road surface when any suspension for the road vehicle wheel is compressed to its maximum extent.

4 Apparatus according to claim 1 wherein the wheel has a pneumatic tire and the side walls of the partial enclosure have lower edges situated alongside the inflated pneumatic tire vertically below the wheel hub.

5 Apparatus according to claim 1 wherein a said air scoop is situated whereby to direct brake cooling air into the partial enclosure in the region of a wheel hub.

6 Apparatus according to claim 4 wherein a said air scoop is situated whereby to direct tire cooling air into the partial enclosure in the region of a wheel tire.

7 Apparatus according to claim 1 wherein the apertures in the forward face of the rear wall panel include elongate apertures extending horizontally across the greater part of the width of the face of the panel to receive liquid water running down the panel and direct it into the internal chamber.

8 Apparatus according to claim 7 comprising lips below the respective elongate apertures to direct the water running down the panel into the apertures.

9 Apparatus according to claim 1 wherein a lower portion of the rear wall panel is angled forwards towards the wheel ahead of it.

10 Apparatus according to claim 1 wherein the water outlet comprises a duct adapted to discharge liquid water on to the road.

11 Apparatus according to claim 1 wherein the water outlet comprises a duct connected to a pump for extracting air and water droplets from the partial enclosure through the apertures in the forward face of the rear wall panel.

12 Apparatus according to claim 1 wherein the water outlet comprises a duct leading to a pump for removing water from the chamber and delivering it to a reservoir.

13 Apparatus according to claim 1 wherein the side walls and the rear wall of the partial enclosure are hinged whereby they can be raised for travel of the vehicle over uneven ground.
